(19) United States
(12) Patent Application Publication
(10) Pub. No.: US 2002/0054491 A1
(43) Pub. Date: May 9, 2002

(54) Lighting apparatus for tools

(76) Inventor: Iram Casas, Baldwin Park, CA (US)

Correspondence Address: Matthew J. Peirce, Esq., 1550 Starlight Canyon Avenue, Las Vegas, NV, 89123, US

(21) Appl. No.: 10/008,667

(22) Filed: Nov. 3, 2001

Related U.S. Application Data
(60) Provisional application No. 60/245,271, filed on Nov. 3, 2000.

(51) Int. Cl. B25B 23/18

(52) U.S. Cl. 362/119

(57) ABSTRACT

A new and improved apparatus is disclosed for use on a variety of hand-held tools. The apparatus would comprise a small light which would be mounted on top of a hand-held tool. The small light would be designed to have a bulb and mounting means in order to properly affix to the power tool. The small light would be designed to project a beam of light in a forward direction in order to ensure that a user would be able to use the particular hand tool in a safer manner when working either in lighted areas or when light is not particularly adequate. The light would preferably be designed to be battery-powered, but could also be designed to be hooked up to the batteries in the attached hand tool or to standard household current.

### I. BACKGROUND OF THE INVENTION

The present invention concerns that of a new and improved apparatus for use on a variety of hand-held tools.

### II. DESCRIPTION OF THE PRIOR ART

U.S. Pat. No. 5,797,670, issued to Snoke et al., discloses a portable power tool light for mounting to a portable power tool and method of using the portable power tool light which include a belt shaped to detachably mount to and surround a distal portion of a portable power tool.

U.S. Pat. No. 5,785,408, issued to Tseng, discloses an illuminating device for a tool which includes a light bulb secured in a housing and one or more batteries.

U.S. Pat. No. 5,461,790, issued to Olstowski, discloses a circular saw for more precise movement during cutting which comprises a circular blade and further comprises a laser device positioned on the shield to project a laser beam in a line from the notch along the workpiece to a line along the direction to be cut.

### III. SUMMARY OF THE INVENTION

The present invention concerns that of a new and improved apparatus for use on a variety of hand-held tools. The apparatus would comprise a small light which would be mounted on top of a hand-held tool. The small light would be designed to have a bulb and mounting means in order to properly affix to the power tool. The small light would be designed to project a beam of light in a forward direction in order to ensure that a user would be able to use the particular hand tool in a safer manner when working either in lighted areas or when light is not particularly adequate. The light would preferably be designed to be battery-powered, but could also be designed to be hooked up to the batteries in the attached hand tool or to standard household current.

There has thus been outlined, rather broadly, the more important features of a tool light in order that the detailed description thereof that follows may be better understood and in order that the present contribution to the art may be better appreciated. There are, of course, additional features of the tool light that will be described hereinafter and which will form the subject matter of the claims appended hereto.

In this respect, before explaining at least one embodiment of the tool light in detail, it is to be understood that the tool light is not limited in its application to the details of construction and to the arrangements of the components set forth in the following description or illustrated in the drawings. The tool light is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present tool light. It is important, therefore, that the claims be regard as including such equivalent constructions insofar as they do not depart from the spirit and scope of the present invention.

It is therefore an object of the present invention to provide a tool light which has all of the advantages of the prior art and none of the disadvantages.

It is another object of the present invention to provide a tool light which may be easily and efficiently manufactured and marketed.

It is another object of the present invention to provide a tool light which is of durable and reliable construction.

It is yet another object of the present invention to provide a tool light which is economically affordable and available for the buying public.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a perspective view of the present invention attached to a hand-held power drill.

FIG. 2 shows a perspective view of the present invention attached to a chain saw.

FIG. 3 shows the present invention in use by a user.

### V. DESCRIPTION OF THE PREFERRED EMBODIMENT

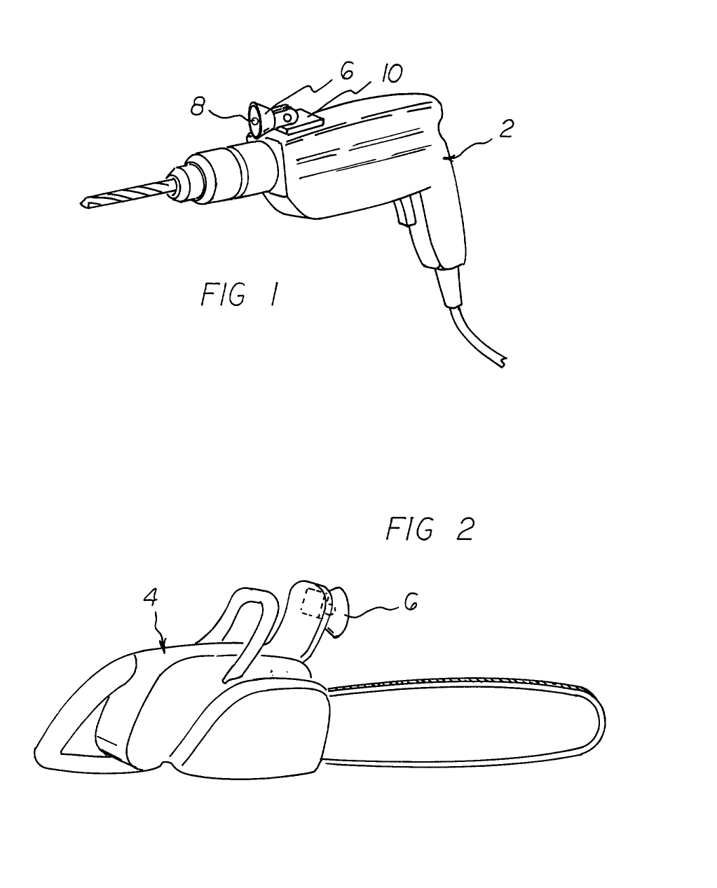

FIGS. 1 and 2 show perspective views of the present invention attached to a hand-held power drill 2 and chain saw 4, respectively. The present invention concerns that of a new and improved apparatus for use on a variety of hand-held tools. The apparatus would comprise a small light 6 which would be mounted on top of a hand-held tool. The small light 6 would be designed to have a bulb 8 and mounting means 10 in order to properly affix to the power tool. The small light 6 would be designed to project a beam of light in a forward direction in order to ensure that a user would be able to use the particular hand tool in a safer manner when working either in lighted areas or when light is not particularly adequate. The light would preferably be designed to be battery-powered, but could also be designed to be hooked up to the batteries in the attached hand tool or to standard household current.

The small light 6 of the present invention would be designed to improve safety and reduce the possibility of an accident which may occur if a user was working in low-light conditions or in darkness. Obviously, it may not be entirely safe to operate some power tools in darkness to begin with, but at the same time, sometimes work needs to get done as soon as possible. In such a situation, small light 6 would help a user out immensely.

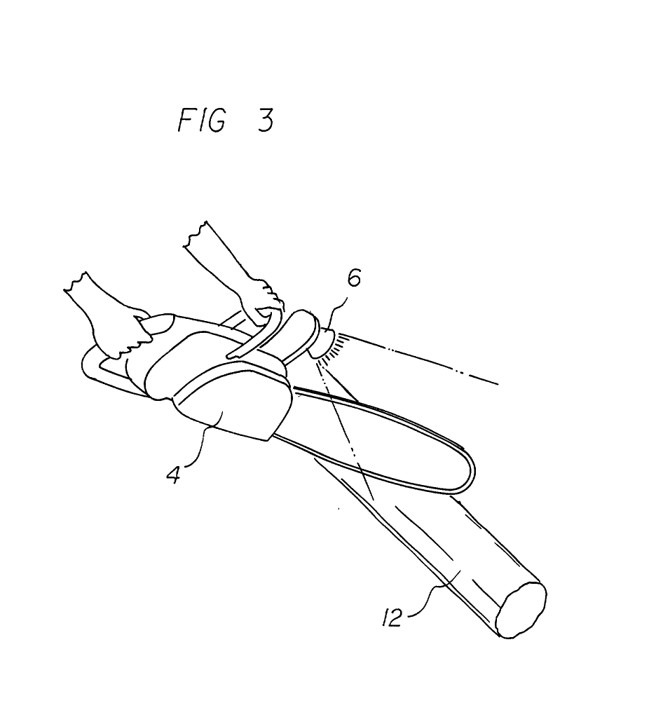

FIG. 3 shows the present invention in use by a user. Small light 6 can be seen providing some extra light to a user who is using chain saw 4 to cut a log 12.

What I claim as my invention is:

1. A small light source in combination with a hand-held tool comprising:
(a) a hand-held tool,
(b) a casing,
(c) a bulb located within the casing,
(d) mounting means for attaching the casing to the hand-held tool,
(e) power means for providing power to the light source,
(f) wherein the light source would be positioned to project a beam of light in a forward direction relevant to the hand-held tool when the tool would be in operation.

2. A small light source in combination with a hand-held tool according to claim 1 wherein the power means would further comprise at least one battery, the battery located within the light source.

3. A small light source in combination with a hand-held tool according to claim 1 wherein the power means would further comprise at least one battery, the battery located within the hand-held tool.

4. A small light source in combination with a hand-held tool according to claim 1 wherein the power means would be standard household current.

5. A small light source in combination with a hand-held tool according to claim 1 wherein the hand-held tool would be a power drill.

6. A small light source in combination with a hand-held tool according to claim 1 wherein the hand-held tool would be a chain saw.
